(19) United States
(12) Patent Application Publication
(10) Pub. No.: US 2012/0066339 A1
(43) Pub. Date: Mar. 15, 2012

(54) Never Out of Reach: A System and Method for Access and Management of Information Across a World Wide Network

(76) Inventor: Alison Andrews, Glen Cove, NY (US)

(21) Appl. No.: 12/881,356

(22) Filed: Sep. 14, 2010

(51) Int. Cl. G06F 15/16

(52) U.S. Cl. 709/217

(57) ABSTRACT

A system and method for accessing and managing historic, current and future information across a world wide network including but not limited to voice, data, internet, wireless and satellite technologies are disclosed. The disclosure includes a unique numerical code (UNC) permanently assigned to an individual user (Reach), the UNC associated with all the Reach's transactions on the world wide network and thereby providing a single point of access (SPA) to the world wide network. The disclosure also includes an electronic filing cabinet (EFC) with content managed by the Reach and linked to the Reach's UNC. Each EFC's content is arranged in multiple secure access levels (SAL) and includes historical, current and future information and data concerning the Reach and Reach contacts (Reachers). An EFC controller is configured to control access for Reachers as defined by the Reach to each SAL.

### BACKGROUND OF THE INVENTION

With ever growing use of the internet and increased worldwide communication, sharing information such as website URL's, e-mail addresses and street addresses across languages and cultures can be complex. Whether it is an individual changing residence and employment or a corporation merging or selling-out to a bigger corporation, individuals, groups and corporations are constantly changing their contact information

Additionally, web based personal information can be lost when its use is terminated and there is no guarantee it can later be searched, located or found. The US Department of Labor statistics show that a worker between the ages of 18 and 38 changes jobs an average of 10 times. This theoretically can mean 10 different work email addresses for the same person. These email addresses are subsequently deactivated after the employee leaves an employer creating a gap in reaching the individual.

Studies reveal that the average person in the United States has 3.1 email addresses and 31% of email addresses get changed every year with more than half the changers losing touch with their contacts. Also, the boom in social networking has increased multiple user names where common names are already taken. Additionally, research by the Census Bureau shows that Americans move roughly every five years with 16% moving each year and 20% moving to another state, county or country. Furthermore, in the United States alone, there are over 1 million women getting married each year causing change of names, address etc., leaving them out of reach.

In some instances, email forwarding services automatically forward emails to a new email address. However, such services typically only forward email for a year and then leave email sent to the old email address undeliverable. Therefore, in today's technological world there is no common way for individuals, groups and corporations to maintain personal data and contact information in most cases for more than 1 to 5 years.

### SUMMARY OF THE INVENTION

A system and method to access and manage historic, current and future information across a world wide network including but not limited to voice, data, internet, wireless and satellite technologies is disclosed. The system includes a universal numerical code (UNC) permanently assigned to an individual (Reach) and to all individuals world wide so that every person has a unique UNC. The UNC is associated with all a Reach's interactions on the world wide network.

The disclosed system also includes an electronic filing cabinet (EFC) comprising a content linked to the UNC. The EFC content is arranged in multiple secure access levels (SAL) managed by the Reach. The EFC content comprises historic, current and future information and data concerning the Reach and Reach contacts (Reachers). The system further includes an EFC controller to control access to each SAL of content in the EFC as defined by the Reach for a number of Reachers on the world wide network. Other system embodiments are also disclosed herein.

A disclosed method for accessing and managing historical, current and future information across a world wide network including but not limited to voice, data, internet, wireless and satellite technologies, includes assigning a permanent and universal numerical code (UNC) to an individual (Reach) and to all individuals world wide so that each person has a unique UNC. The method also includes associating the UNC with all the Reach's interactions on the world wide network. The method further includes linking an electronic filing cabinet (EFC) to the UNC. The EFC comprises content arranged in a number of secure access levels (SAL) managed by the Reach where the EFC content includes historic, current and future information and data concerning the Reach and Reach contacts (Reachers). Access to the EFC contents at each SAL is also determined and controlled by the Reach for a number of Reachers. Other method embodiments are also enclosed herein.

Embodiments of a computer program product are described comprising a computer readable medium having computer useable program code executable to perform operations for accessing and managing historical, current and future information across a world wide network including but not limited to voice, data, internet, wireless and satellite technologies. The operations of the computer program product include assigning a permanent and universal numerical code (UNC) to an individual (Reach) and to all individuals world wide so that each person has a unique UNC. The operations of the computer program product also include associating the UNC with all the Reach's interactions on the world wide network and linking an electronic filing cabinet (EFC) to the UNC. The EFC comprises content arranged in a plurality of secure access levels (SAL) managed by the Reach where the EFC content includes historic, current and future information and data concerning the Reach and Reach contacts (Reachers). The operations of the computer program product further include controlling access to the EFC contents at each secure access level as determined by the Reach for a number of Reachers.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a system to access and manage historic, current and future information across a world wide network in accordance with an embodiment including a UNC, an EFC linked to the UNC and an EFC controller.

FIG. 2 depicts a distributed system to access and manage historic, current and future information across a world wide network in accordance with an embodiment

FIG. 3 depicts a block diagram of the EFC in accordance with an embodiment including a time capsule configured to be broadcast over the world wide network to Reachers predetermined by the Reach.

FIG. 4 is a block diagram of the EFC Controller in accordance with an embodiment.

FIG. 5 depicts an arrangement of linear files in the EFC in accordance with an embodiment.

FIG. 6 depicts an arrangement of hierarchical files and linear files in the EFC in accordance with an embodiment.

FIG. 7 depicts a diagram of a method for accessing and managing historical, current and future information across a world wide network in accordance with an embodiment.

FIG. 8 depicts a diagram of a method for creating a time capsule and broadcasting the time capsule over a world wide network in accordance with an embodiment.

FIG. 9 depicts a diagram of a method for providing access to secure access levels within the EFC content as predetermined by the Reach.

Throughout the description, similar reference numbers may be used to identify similar elements.

### DETAILED DESCRIPTION

The present disclosure allows people to communicate and share contact information and other types of information with ease by means of a unique and permanent universal numerical code (UNC) assigned to every individual. Communications through the UNC as a single point of access (SPA) over a world wide network may be transacted through the internet, telephony, satellite, SMS, instant messaging, mobile, data, VOIP and any other forms of technology. The present disclosure also provides for complete security of data and information through the ability to set secure access levels (SAL) for individuals and groups to information and data linked to the UNC.

The present disclosure assigns a UNC to each individual, group, organization or corporation regardless of their geographical location in the world. Hereinafter the owner of a UNC will be referred to as the Reach and those communicating with the Reach will be referred to as Reachers. Therefore a Reach and a Reacher may be individuals, groups, organizations and corporations. This UNC allows entry onto a database in an electronic filing cabinet (EFC) linked to a UNC in which the Reach can store, read and distribute all his information to Reachers identified by their UNC. The numerical code is machine readable by any bar code reader, any form of computer readable medium and can be manually input into an electronic device.

Therefore, the disclosed system may also serve as a single point of access (SPA) to a world wide network for individuals, groups, organizations and corporations to share, forward, store and consolidate all their information in perpetuity. Personal or corporate EFC may be easily accessed by UNC respectively assigned. The Reach may have complete autonomy to control and manage their EFC with the ability to administer their own SAL. The single point of access SPA may allow for the complete consolidation of the identity history of a Reach by storing all the Reach's information including but not limited to, email addresses, social networking user names, membership user names and all Reacher's numerical codes. The Reach may also be able to gain access to all his contacts and sites from the SPA including but not limited to, FACEBOOK, TWITTER, IGOOGLE, MYSPACE, LINKEDIN, Blogs, Websites, and Bank Accounts from his home page with his UNC.

EFC content changed, updated and added to will be available in real time to all the Reachers of the Reach. The Reach will also be able to automatically send a notification to all his Reachers through the internet and peripheral connections such as telephony, VOIP, satellite, GPS, IMAR sat and/or any non digital input via voice or/or other forms of input. Therefore, anyone in possession of a UNC may have remote access to manage their EFC content. Using an interactive system and/or call center, the Reach or the Reacher may be able to access contacts and information by entering his UNC. The Reach and the Reacher will also be able to acknowledge requests, check notifications and find contact details. Therefore, a Reacher may be able to contact any Reach and access information concerning the Reach at specific secure access levels given the Reach has pre-authorized his access.

Historical information may be searchable on the EFC database. The Reach can enter all previously known details including but not limited to email addresses, landline numbers, addresses, and mobile numbers, together with the time period of known ownership. Therefore, a Reacher may be able to find a Reach through historically know information. A Reach can either allow a REACHER to have his new email address or allow an email to be sent blind to the Reach so the Reacher does not know the email address.

An EFC database may use many different methods of verification and authentication in various different forms. A Reach's UNC may also allow for Certification of Reach and Reacher by displaying a special symbol that may be generated from a checksum scheme of the UNC. Where identity fraud is a major problem, full security measures may be implemented including but not limited to, voice biometrics software, random session keys and digital certificates for access to sensitive information. Also differing symbols may indicate how secure a person is and if they have been compromised in the past. To ensure further security, the Reach can transmit a daily numeric code to its Reachers. This daily code may have to be entered manually to gain access to sensitive information.

A disclosed time capsule may allow for information to be securely held and invisible to the public until a date given for release has been reached. The time capsule may be used for a future press release or the upcoming launch of a product or even a video greeting of a grandparent to a grandchild. The disclosed time capsule may give a Reach peace of mind that sensitive information will be automatically distributed on time to the right individual(s). Someone may wish to store their memoirs only to be released after their demise or a special message to be stored and released when their child attains a certain age or certain level or maturity.

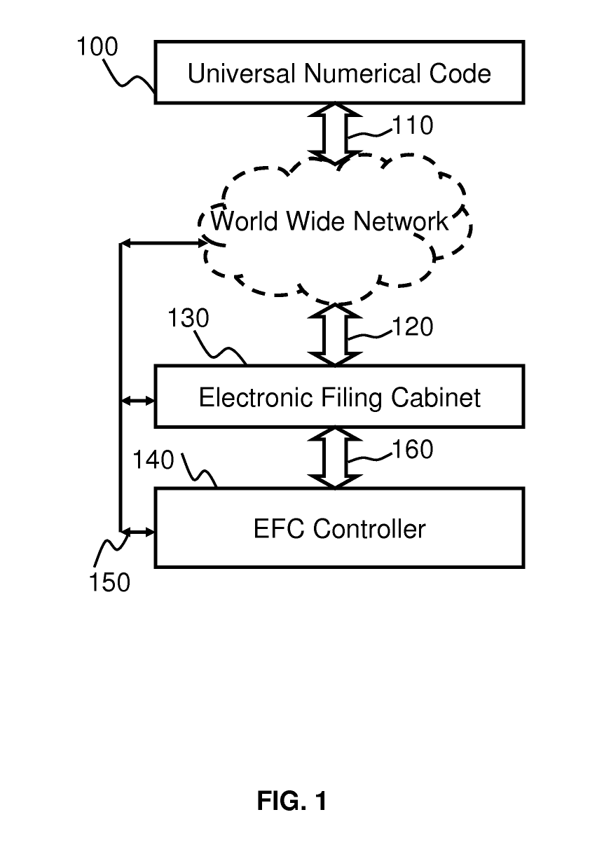

FIG. 1 depicts a system to access and manage historic, current and future information across a world wide network in accordance with an embodiment including a UNC, an EFC linked to the UNC and an EFC controller. The system includes the universal numerical code (UNC) 100, a single point of access 110 to the world wide network, a multiple access point 120 to the world wide network, the electronic filing cabinet (EFC) 130 linked to the UNC 100 through the multiple access point 120 and the world wide network, an EFC controller 140, a control bus 150 in communication with the EFC 130 and the world wide network and a data bus 160 between the EFC 130 and the world wide network. The world wide network includes but is not limited to voice, data, internet, wireless and satellite technologies and therefore may include the internet and the world wide web. Therefore, the single point of access 110 and the multiple access point 120 to the world wide network may also be through voice, data, internet, wireless and satellite technologies. The universal numerical code (UNC) 100 is permanently assigned to an individual (Reach) and to all individuals world wide so that every person has a unique UNC 100. The UNC 100 is associated with all a Reach's interactions on the world wide network and therefore acts as a single point of access (SPA) 110 to the world wide network. In an embodiment, the SPA 110 may comprise a webpage for the Reach including links to the Reach's EFC 130 and controller 140 and hyperlinks to websites and links to Reachers having previous interactions with the Reach. More specifically, a link allows the Reach to jump to another webpage or address on the world wide network by activating the link.

The electronic filing cabinet (EFC) 130 comprises content linked to the UNC 100. The EFC 130 content may be numerically linked to the UNC 100 by the association of the UNC 100 with all content in the EFC 130. More specifically, EFC 130 content may be identified by metadata associated with the UNC 100. The metadata may be data describing and data associated with the structure, context and meaning of the EFC 130 content. The metadata may be used by the controller 140 to organize and interpret the EFC 130 content into meaningful information. The metadata may also be used as tags in HTML and XML read by the controller 140. The electronic filing cabinet may be electronic memory in a personal computer, a workstation, a server, a microprocessor, a microcontroller and any combination of the foregoing electronic devices and electronic memory.

The Reach information and data may further include personal physical addresses, phone numbers, fax numbers, mobile phone numbers, website URLs, email addresses, Skype names and numbers, IM names and numbers, blogs, data, graphics, photographs, birth certificates, passport information, credit cards, social security numbers, tax identification numbers, insurance policies, driver licenses, memberships, memoirs, educational records, resume/Curriculum Vitae, medical records, marriage certificates, divorce records, bank records, last will and testaments, real estate records, and insurance policies and any other personal information and data as determined by the Reach including lists of Reachers and Reacher's addresses, links and other contact information.

The Reach information and data may also include a general medical form including general medical information concerning the Reach, a general insurance form including general insurance information concerning the Reach, a general financial form including general financial information concerning the Reach, and any other general forms including any other information concerning the Reach as determined necessary and/or desirable by the Reach.

The present disclosure also provides an emergency contact point. Where someone's UNC is written in their wallet or put in their car or put on an ID bracelet, emergency medical personnel can access their EFC for information about allergies, next of kin, and emergency notification lists through secure authorization. With secure authorization, medical records can be accessed in the event a Reach has preauthorized access to medical personnel.

The system of FIG. 1 further includes an EFC controller 140 configured to control access to the EFC 130 at secure access levels SAL as determined by the Reach. The controller 140 may be a personal computer, a workstation, a server, a microprocessor, a microcontroller and any combination of the foregoing that are programmable in software or in hardware. It is the Reach who defines which secure access levels a Reacher may be able to access across the world wide network. The Reach has access to all secure access levels within the Reach's EFC 130.

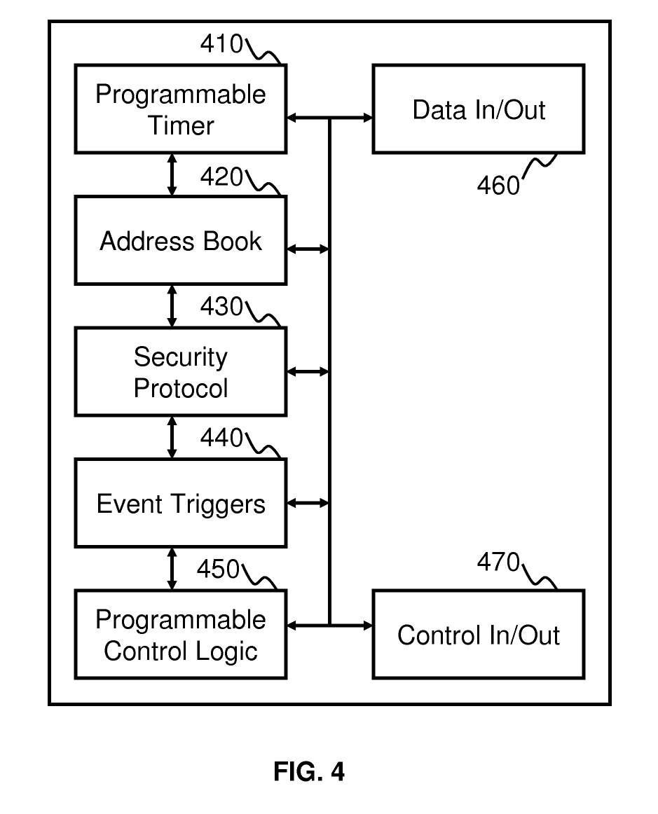

In the depicted embodiment, the controller 140 is local to the EFC and therefore may have a dedicated multidirectional data bus 160. However, the control bus 150 may multidirectionally communicate directly with the world wide network and directly with the EFC 130. Therefore, timing latencies are minimized in control and data operations between the EFC and the controller. Further detail concerning the controller 140 internal configuration is discussed below in connection with FIG. 4.

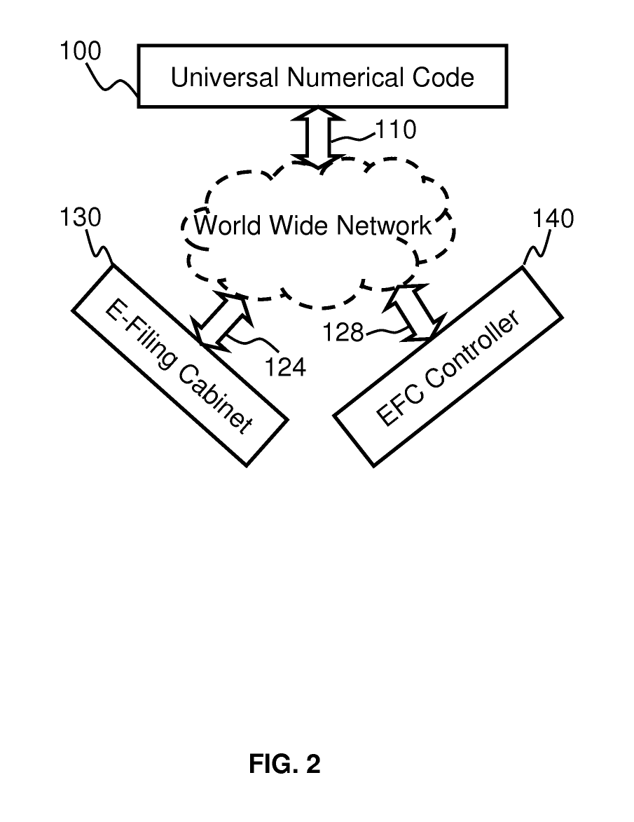

FIG. 2 depicts a distributed system to access and manage historic, current and future information across a world wide network in accordance with an embodiment. The distributed system includes a universal numerical code (UNC) 100, a single point of access 110 to the world wide network, an electronic filing

cabinet (EFC) 130 linked to the UNC 100 through the world wide network at the first multiple access point 124, and an EFC controller 140 linked to the UNC 100 through the world wide network at the second multiple access point 128. The world wide network may include but may not be limited to voice, data, internet, wireless and satellite technologies and therefore may include the internet and the world wide web. Therefore, the single point of access 110, the first multiple access point 124 and the second multiple access point 128 to the world wide network may also allow communication through voice, data, internet, wireless and satellite technologies. This depicted embodiment may increase timing latencies between the EFC and controller but is advantageous for flexibility in programming and managing the controller where the EFC may be distributed at other points in the world wide network. Therefore, control and data operations between the EFC 130 and the controller 140 occur over the world wide network through the first multiple access point 124 and the second multiple access point 128.

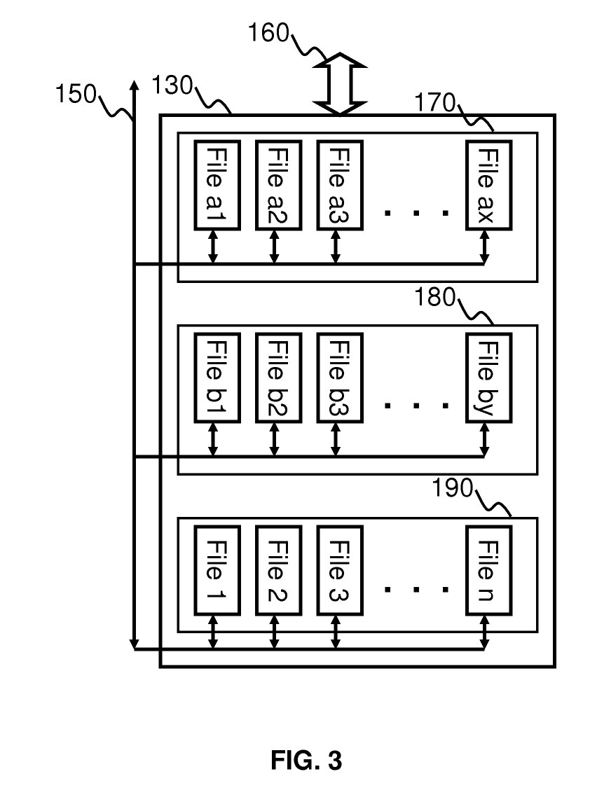

FIG. 3 depicts a block diagram of the EFC in accordance with an embodiment including a time capsule configured to be broadcast over the world wide network to Reachers predetermined by the Reach. The EFC 130 content is managed by the Reach and arranged in multiple secure access levels (SAL) such as a first SAL 170, a second SAL 180 and SAL 190 also known as the time capsule. Though three secure access levels are depicted, any arbitrary number of secure access levels may be included in the EFC 130. The EFC 130 content comprises historic, current and future information and data concerning the Reach and Reach contacts (Reachers). The information may be processed data. The data may include metadata concerning the Reach and Reachers. The EFC 130 may be contained in a central physical location or may be distributed across the world wide network in multiple physical locations. The scope and content of the information and data are further discussed below. Secure access level 170 may contain the files a1, a2, a3 and more files up to and including file ‘ax.’ Secure access level 180 may contain the files b1, b2, b3 and more files up to and including file ‘by.’ Secure access level 190 may contain the files 1, 2, 3 and more files up to and including the file ‘n.’ As detailed below, the controller 140 allows access to a file in a specific SAL according to predetermined permissions set by the Reach for each Reacher for each SAL.

The third secure access level 190 depicted in FIG. 2 comprises a time capsule in an embodiment. That is, at least some of the Reach's EFC content may comprise a time capsule configured to be broadcast over the world wide network and associated peripheral technologies to Reachers predetermined by the Reach. The broadcast may be triggered by at least one life's event or a social event or an event of the Reach's choosing including the expiration of a period of time. Also in an embodiment, single and multiple amendments to a Reach's EFC contents may be broadcast over the world wide network to Reachers predetermined by the Reach, the broadcast triggerable by at least one event defined by the Reach.

A life's event may be a birth, a death or a marriage of a close family relation or friend and any other event as defined by the Reach including events associated with a Reach's Avatar and relations in virtual reality and cyberspace on the world wide network such as in alternate realities and massively multiplayer online games (MMOGs). A social event may be a party, a gathering, a meeting and any other event as defined by the Reach including events occurring in virtual realities and cyberspace on the world wide network such as in alternate realities and MMOGs.

Secure access levels may comprise acquaintance level, co-worker level, neighbour level, club level, church level, friend level, extended family level, immediate family level, close friend level, professional level, spousal level/significant other level, self level and any other level(s) of secure access as determined by the Reach. The professional level of security may comprise medical doctors, accountants, and lawyers who access the Reach's personal information and data on an emergency basis or on a need-to-know basis in accordance with privacy laws of the Reach's residence, locale, state and country.

All EFC content is readable and writeable at all secure access levels exclusively by the Reach. EFC content at specific secure access levels is readable by a Reacher to whom the Reach grants permission on a limited basis. Also, all the EFC content is backed-up periodically throughout the world wide network to provide a permanent history of the Reach's historic, current and future information and data and links to Reachers. The periodic backup also provides a permanent history of Reachers having previous connection with the Reach. The backup may be performed from a central memory or may be performed across the world wide network from multiple and distributed memory devices.

FIG. 4 is a block diagram of the EFC Controller in accordance with an embodiment. The EFC controller is fully programmable and comprises a timer module 410, an address book 420, a security protocol module 430, an events trigger module 440, a control logic module 450, a data in/out module 460 and a control in/out module 470. All modules in the controller 140 are in multidirectional communication with each other in series and in parallel as depicted. Also, the modules comprising the controller 140 are able to communicate with devices outside the controller 140 through a data bus and a control bus. The programmable timer module 410 may be programmed to trigger a timed signal variable upon reaching a predetermined time as determined by the Reach. The address book 420 may be configured to hold a plurality of Reacher's addresses and links at various SAL. The security protocol module 430 may be configured to match a Reacher's UNC to the Reacher's SAL as predetermined by the Reach. The event triggers module 440 may be configured to trigger an event signal variable upon completion of a predetermined event as determined by the Reach. The programmable control logic module 450 may be configured to provide all glue logic for the controller to allow all modules of the controller to operate with each other and with outside variables, signals and modules. As mentioned earlier in the disclosure, the controller 140 may be a personal computer, a workstation, a server, a microprocessor, a microcontroller and any combination of the foregoing that are programmable in software or in hardware. Therefore, the controller 140 may be programmed directly or remotely through a local port or through the world wide network respectively.

The controller may also allow the Reach to personally acknowledge and allow an access request from Reachers to his/her EFC content and also acknowledge and allow access requests using the EFC controller. The controller may be programmed with a list of Reachers allowed to access specific levels of secure content in the Reach's EFC as predetermined by the Reach.

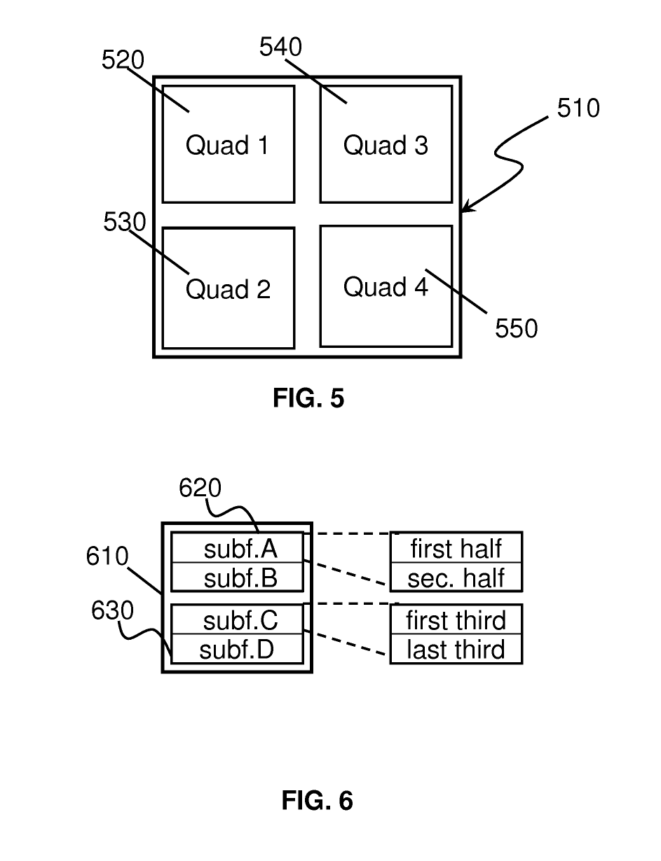

FIG. 5 depicts an arrangement of linear files in the EFC content in accordance with an embodiment. The Reach's EFC content may reside in any number of linear files. A linear file comprises personal information and data that may be redacted to form a less personal copy of the linear file at a less secure access level. The depicted embodiment includes the linear file 510 comprising quadrant 1 (520), quadrant 2 (530), quadrant 3 (540), and quadrant 4 (550). The Reach may break up a file into any number of arbitrary areas to assign secure access levels. The Reach may predetermine that quadrants 1 and 2 are accessible at a first secure access level and that quadrants 3 and 4 are accessible at a second secure access level. Therefore, a Reacher for whom the Reach has granted access to the first secure access level will only be able to view quadrants 1 and 2 but not quadrants 3 and 4 which are redacted from the Reacher's view or read access but are still present in the file 510. A Reacher for whom the Reach has granted access to the first and second access levels will be able to view and have read access to all four quadrants with no content redacted from his or her view. However, a Reacher may at no time have write access to the linear file 510. The linear file 510 may be a text file, a digital photograph, a music file, a video file or any other type of file containing data. Therefore, quadrants merely represent quarter portions of the linear file which may be assigned secure access levels by the Reach. However, non-equal portions may also be created by the Reach for assigning secure access levels to a Reacher.

FIG. 6 depicts an arrangement of hierarchical files in the EFC content in accordance with an embodiment. In the depicted embodiment, the EFC content may include a number of hierarchical files wherein a most secure file is a subset of a least secure file in the same hierarchical file at a less secure access level. The depicted hierarchical file 610 includes a first sub-file 620 and a second sub-file 630. The first sub-file 620 may further include sub-files A and B as depicted. The second sub-file 630 may further include sub-files C and D as depicted. Within the hierarchical file 610, the Reach has determined that the first sub-file 620 is accessible on a second SAL and the second sub-file 630 is accessible on a third SAL. Therefore, a Reacher for whom the Reach has granted access to the second secure access level will be able to access sub-files A and B within the first sub-file but not be able to access sub-files C and D within the second sub-file 630. A Reacher for whom the Reach has granted access to the second and third access levels will be able to access and view all four sub-files. The Reach may also determine that the entire hierarchical file 610 and all its hierarchical sub-files are accessible to all the world by setting the hierarchical file 610 SAL to a null secure access level for all UNC users. The Reach may also determine that the entire hierarchical file 610 and all its hierarchical sub-files are accessible only to his or her immediate family by setting the hierarchical file SAL to a null secure access level for his or her immediate family either as a group or as individuals.

Furthermore, FIG. 6 depicts sub-file A split into linear halves labeled ‘first half’ and ‘sec. half’ and depicts sub-file C split into linear parts labeled ‘first to third’ and ‘last third.’ In an embodiment of the disclosure, the Reach may also assign linear portions of hierarchical sub-files to specific secure access levels with access permissions granted to specific Reachers. In the embodiment depicted, the Reach may assign the first half of sub-file A to a first SAL for a first Reacher and the second half of sub-file A to a second SAL for a second Reacher. Therefore, though the first Reacher may have access granted by the Reach to the first SAL for the hierarchical file 610 and therefore may read the ‘first half’, the first Reacher is not able to access the second linear half of sub-file A. The second Reacher is able to access the second linear half of sub-file A and the first linear half. The first third and the last third of sub-file C may be granted secure access levels for a Reacher or a group of Reachers but where a part is not assigned an access level, such as the middle third of sub-file C, it may default to a null SAL for all UNC users.

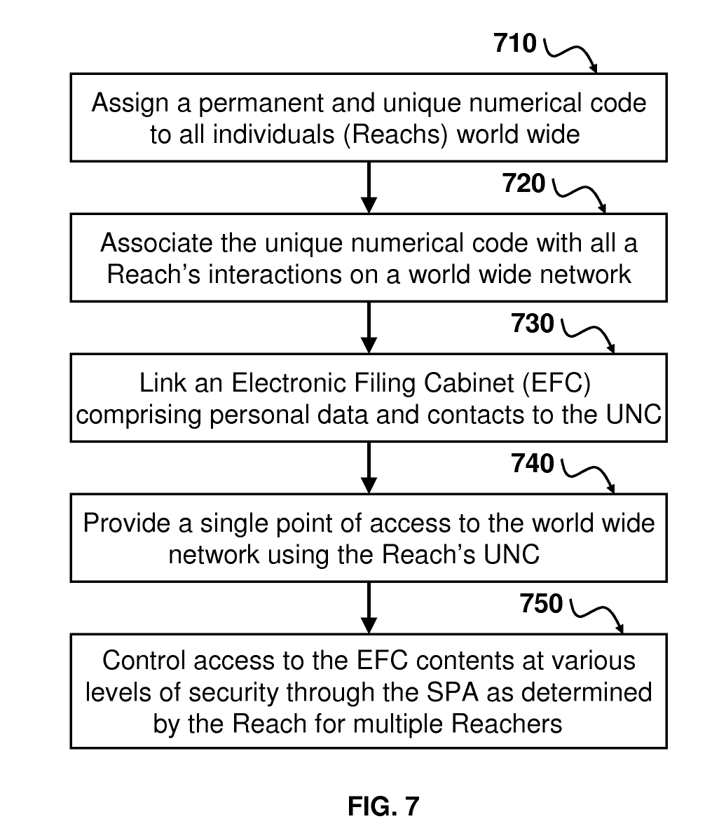

FIG. 7 depicts a diagram of a method for accessing and managing historical, current and future information across a world wide network in accordance with an embodiment. The method includes assigning 710 a permanent and universal numerical code (UNC) to an individual user (Reach) on a world wide network. All individual users on the world wide network are assigned a unique UNC. The method also includes associating 720 the UNC with all the Reach's interactions on the world wide network. Furthermore, the method includes linking 730 an electronic filing cabinet (EFC) to the UNC where the EFC content may be arranged into secure access levels managed by the Reach. The EFC content includes historic, current and future information and data concerning the Reach and the Reach's contacts known herein as Reachers. The disclosed method may also include providing 740 a single point of access to the world wide network using the Reach's UNC. Controlling 750 access to the EFC contents at each secure access level (SAL) may also be determined by the Reach for a number of Reachers.

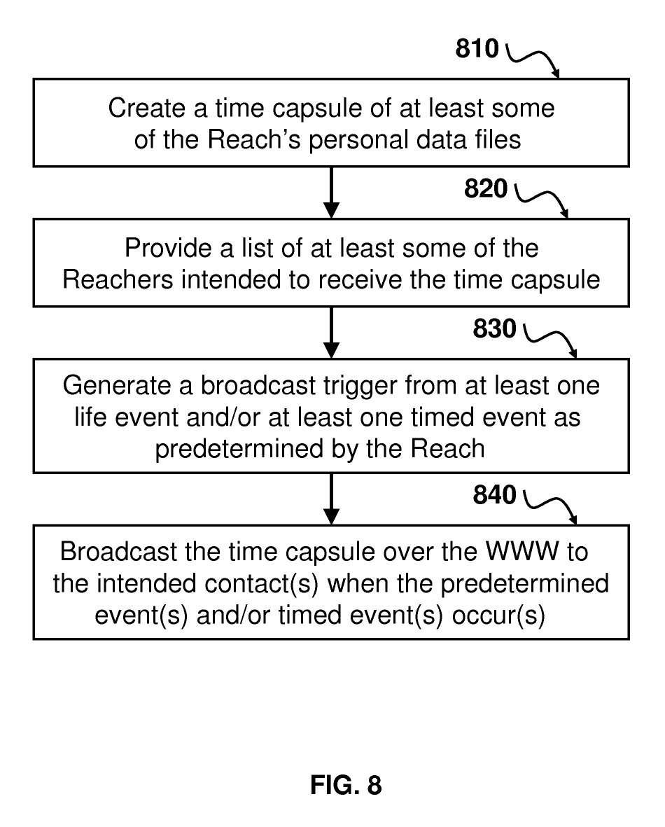

FIG. 8 depicts a diagram of a method for creating a time capsule and broadcasting the time capsule in accordance with an embodiment. The method includes creating 810 a time capsule of at least some of the Reach's EFC content. The method also includes providing 820 a list of at least some of the Reachers intended to receive the time capsule as predetermined by the Reach. The method additionally includes generating 830 a broadcast trigger from at least one life event and/or at least one timed event as predetermined by the Reach. The method further includes broadcasting 840 the time capsule over the world wide network and associated peripheral technologies to the intended Reacher(s) when the predetermined event(s) and/or timed event(s) occur(s).

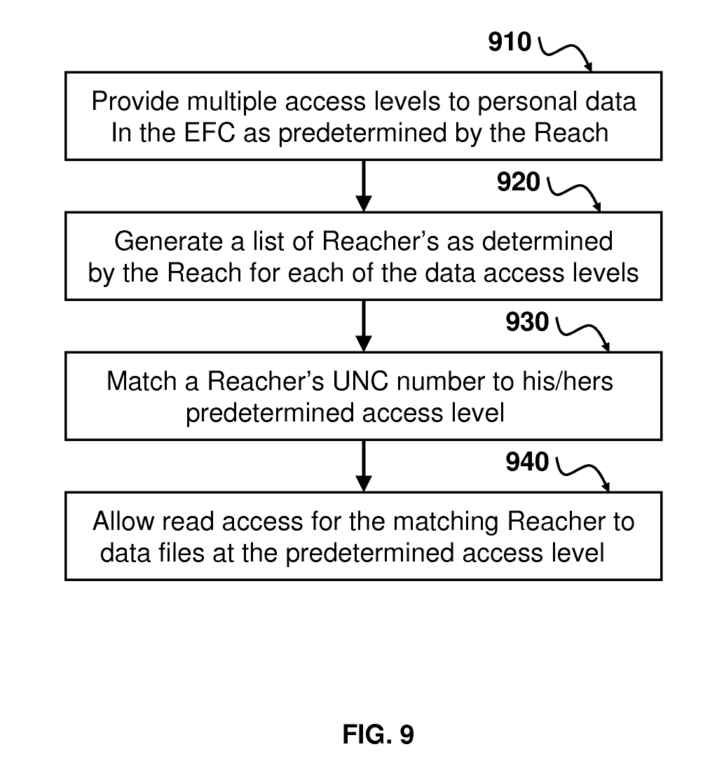

FIG. 9 depicts a diagram of a method for providing access to EFC content as predetermined by the Reach. The method includes providing 910 multiple secure access levels to personal data in the EFC as predetermined by the Reach. The method also includes generating 920 a list of at least one Reacher and other Reachers having access to each specific secure access level as predetermined by the Reach. The method additionally includes matching 930 a Reacher's UNC number to his/hers predetermined access level and allowing 940 read access for the matching Reacher to content in the EFC at the predetermined secure access level. Reachers do not have write access to data and information in a Reach's EFC.

The present disclosure provides a SPA for organizing, storing, changing, forwarding, sharing and consolidating information with detailed levels of secure access and permissions. Also, the disclosure addresses the issue of multiple websites that users must go to access personal information. A Reach SPA website may provide the Reach the ability to consolidate all their accounts protected with one username and password and to have easy access to sites on which they are registered through hyperlinks.

The UNC may also be encoded on business cards as a bar code or put on envelopes for the post office to identify and deliver mail. The UNC may also facilitate any form of conveyance of information by using one simple exclusive UNC. Sophisticated encoding techniques may also allow a UNC to be encoded into a photograph of the Reach in the color and contours of the photograph as a means of authentication. Likewise a UNC may be encoded into voice and data transmissions as a means of authenticating communication.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for access and management of historic, current and future information across a world wide network including but not limited to voice, data, internet, wireless and satellite technologies, comprising:
a universal numerical code (UNC) permanently assigned to an individual (Reach), all individuals world wide having a unique UNC, the UNC associated with all the Reach's interactions on the world wide network;
an electronic filing cabinet (EFC) comprising a content linked to the UNC, the EFC content arranged in a plurality of secure access levels (SAL) managed by the Reach, the EFC content comprising a plurality of historic, current and future information and data concerning the Reach and Reach contacts (Reachers); and
an EFC controller configured to control access to each secure access level (SAL) of content in the EFC as defined by the Reach for a plurality of Reachers on the world wide network.

2. The system for access and management of historic, current and future information across a world wide network of claim 1, wherein the UNC comprises a single point of access (SPA) to the world wide network for the Reach, and wherein the SPA further comprises a webpage for the Reach including a link to the Reach's EFC and controller and a plurality of links to websites and Reachers determined by the Reach and at least one link to websites and Reachers having previous interactions with the Reach.

3. The system for access and management of historic, current and future information across a world wide network of claim 1, wherein all EFC content is readable and writeable at all secure access levels (SAL) exclusively by the Reach and wherein EFC content at specific access levels is readable by a Reacher to whom the Reach grants permission on a limited basis to at least one specific secure access level.

4. The system for access and management of historic, current and future information across a world wide network of claim 1, wherein all the EFC content is backed-up periodically throughout the world wide network to provide a permanent history comprising the Reach's historic, current and future information and data and links to Reachers determined by the Reach and/or having a previous connection with the Reach.

5. The system for access and management of historic, current and future information across a world wide network of claim 1, wherein the EFC controller comprises:
a programmable timer module configured to trigger a timed electronic signal upon reaching a predetermined time;
an programmable address book configured to hold a plurality of Reacher's addresses and links at various SAL;
a programmable security protocol module configured to match a Reacher's UNC number to the Reacher's secure access level as predetermined by the Reach;
an programmable event triggers module configured to trigger an event electronic signal upon completion of a predetermined logical event as determined by the Reach; and
a programmable control logic module configured to provide all glue logic for the controller to allow all modules of the controller to operate with each other and with outside variables, signals and modules.

6. The system for access and management of historic, current and future information across a world wide network of claim 1, wherein the Reach information may comprise a general medical form including general medical information concerning the Reach, a general insurance form including general insurance information concerning the Reach, a general financial form including general financial information concerning the Reach, and any other general forms including any other information concerning the Reach as determined necessary and/or desirable by the Reach.

7. The system for access and management of historic, current and future information across a world wide network of claim 1, wherein the Reach information and data may further comprise personal physical addresses, phone numbers, fax numbers, mobile phone numbers, website URLs, email addresses, Skype names and numbers, IM names and numbers, blogs, data, graphics, photographs, birth certificates, passport information, credit cards, social security numbers, tax identification numbers, insurance policies, driver licenses, memberships, memoirs, educational records, resume/CV, medical records, marriage certificates, divorce records, bank records, last will and testaments, real estate records, and insurance policies and any other personal information and data as determined by the Reach including lists of Reachers and Reacher's addresses, links and other contact information.

8. The system for access and management of historic, current and future information across a world wide network of claim 1, wherein the Reach may personally acknowledge and allow an access request from Reachers to the Reach's EFC content and also acknowledge and allow access requests using the EFC controller, the controller programmable with a list of Reachers allowed to access specific levels of secure content in the Reach's EFC as predetermined by the Reach.

9. The system for access and management of historic, current and future information across a world wide network of claim 1, wherein the plural secure access levels (SAL) may comprise acquaintance level, co-worker level, neighbour level, club level, church level, friend level, extended family level, immediate family level, close friend level, professional level, spousal level/significant other level, self level and any other level(s) of secure access as determined by the Reach.

10. The system for access and management of historic, current and future information across a world wide network of claim 9, wherein the professional level of security may comprise medical doctors, accountants, and lawyers who access the Reach's personal information and data on an emergency basis or on a need-to-know basis in accordance with privacy laws of the Reach's residence, locale, state and country.

11. The system for personal data management and contact information management of claim 1, wherein the Reach's EFC content resides in a plurality of linear files wherein a linear file having personal information and data may be redacted to form a less personal copy of the linear file at a less secure access level.

12. The system for access and management of historic, current and future information across a world wide network of claim 1, wherein the Reach's EFC content may further reside in a plurality of hierarchical files wherein a most secure file in a hierarchical file may be a subset of a least secure file in the same hierarchical file at a less secure access level.

13. The system for access and management of historic, current and future information across a world wide network of claim 1, wherein at least some of the Reach's EFC content resides in a time capsule configured to be broadcast over the world wide network and associated peripheral technologies to Reachers predetermined by the Reach, the broadcast triggerable by at least one life's event or a social event or an event of the Reach's choosing including the expiration of a period of time.

14. The system for access and management of historic, current and future information across a world wide network of claim 13, wherein a life's event may be a birth, a death or a marriage of a close family relation or friend and any other event as defined by the Reach including events associated with a Reach's Avatar and relations in virtual reality and cyberspace on the world wide network such as in alternate realities and massively multiplayer online games (MMOGs).

15. The system for access and management of historic, current and future information across a world wide network of claim 13, wherein a social event may be a party, a gathering, a meeting and any other event as defined by the Reach including events occurring in virtual realities and cyberspace on the world wide network such as in alternate realities and MMOGs.

16. The system for access and management of historic, current and future information of claim 1, wherein a single and a plurality of amendments to a Reach's EFC contents may be broadcast over the world wide network to Reachers predetermined by the Reach, the broadcast triggerable by at least one event defined by the Reach.

17. A method for accessing and managing historical, current and future information across a world wide network including but not limited to voice, data, internet, wireless and satellite technologies, comprising:
assigning a permanent and universal numerical code (UNC) to an individual (Reach), all individuals world wide having a unique UNC;
associating the UNC with all the Reach's interactions on the world wide network;
linking an electronic filing cabinet (EFC) to the UNC, the EFC having content arranged in a plurality of secure access levels managed by the Reach, the EFC content comprising a plurality of historic, current and future information and data concerning Reach and Reach contacts (Reachers); and
controlling access to the EFC contents at each secure access level as determined by the Reach for a plurality of Reachers.

18. The method for accessing and managing information across a world wide network of claim 17, further comprising:
creating a time capsule of at least some of the Reach's EFC content;
providing a list of at least some of the Reachers intended to receive the time capsule as predetermined by the Reach;
generating a broadcast trigger from at least one life event and/or at least one timed event as predetermined by the Reach; and
broadcasting the time capsule over the world wide network and associated peripheral technologies to the intended Reacher(s) when the predetermined event(s) and/or timed event(s) occur(s).

19. The method for accessing and managing information across a world wide network of claim 17, wherein controlling access to the Reacher's EFC content at each secure access level as determined by the Reach further comprises:
generating a list of at least one Reacher and other Reachers having access to each specific secure access level as predetermined by the Reach;
matching a Reacher's UNC number to a Reacher's predetermined access level; and
allowing read access for the matching Reacher to content in the EFC at the predetermined secure access level.

20. A computer program product comprising a computer readable medium having computer useable program code executable to perform operations for accessing and managing historical, current and future information across a world wide network including but not limited to voice, data, internet, wireless and satellite technologies, the operations of the computer program product comprising:
assigning a permanent and universal numerical code (UNC) to an individual (Reach), all individuals world wide having a unique UNC;
associating the UNC with all the Reach's interactions on the world wide network;
linking an electronic filing cabinet (EFC) to the UNC through the world wide network, the EFC having content arranged in a plurality of secure access levels managed by the Reach, the EFC content comprising a plurality of historical, current and future Reach information and data concerning the Reach and Reach contacts (Reachers); and
controlling access to the EFC contents at each secure access level through a single point of access as determined by the Reach for a plurality of Reachers.
